(19) United States
(12) Patent Application Publication
(10) Pub. No.: US 2019/0025830 A1
(43) Pub. Date: Jan. 24, 2019

(54) WIRELESS CHARGING AND PROTECTION FOR UNMANNED DELIVERY AERIAL VEHICLES

(71) Applicant: Walmart Apollo, LLC, Bentonville, AR (US)

(72) Inventor: John J. O'Brien, Farmington, AR (US)

(21) Appl. No.: 16/044,094

(22) Filed: Jul. 24, 2018

Related U.S. Application Data
(60) Provisional application No. 62/536,315, filed on Jul. 24, 2017.

(51) Int. Cl. G05D 1/00; H02J 50/12; H02J 7/02; H02J 50/80

(52) U.S. Cl. CPC G05D 1/0088; H02J 50/12; B64C 2201/141; H02J 50/80; H02J 7/025

(57) ABSTRACT

Systems, apparatuses, and methods are provided herein for charging and protecting unmanned aerial vehicles. A method for protecting unmanned aerial vehicle (UAV) navigation system during deliveries of commercial products to customers comprises establishing, with a communication device on a UAV, wireless communication with a charger device, controlling a flight system for providing locomotion to the UAV to land the UAV on the charger device, causing, with a control circuit of the UAV, the UAV to enter a protection mode, wherein the protection mode comprises turning off at least a magnetometer of a sensor system configured to collect data on the UAV, sending a protection mode confirmation signal to the charger device via the communication device to cause the charger device to turn on a wireless charger, and beginning to charge a battery of the UAV with electrical charge received from the wireless charger via a wireless charge receiver.

### CROSS-REFERENCE TO RELATED APPLICATION

This application claims the benefit of the following U.S. Provisional Application No. 62/536,315 filed Jul. 24, 2017, which is incorporated herein by reference in its entirety.

### TECHNICAL FIELD

This invention relates generally to unmanned vehicles.

### BACKGROUND

An unmanned vehicle generally refers to a motored vehicle without a human driver or pilot onboard.

### BRIEF DESCRIPTION OF THE DRAWINGS

Disclosed herein are embodiments of apparatuses and methods for providing protection while wirelessly charging unmanned aerial vehicles (UAV). This description includes drawings, wherein:

FIG. 1 is a system diagram of a system in accordance with several embodiments;

FIG. 2 is a block diagram of a system in accordance with several embodiments; and

FIG. 3 is a flow diagram of a method in accordance with several embodiments;

FIG. 4 is a flow diagram of a method in accordance with several embodiments;

FIG. 5 is a flow diagram of a method in accordance with several embodiments;

FIG. 6 is a flow diagram of a method in accordance with several embodiments;

FIG. 7 is a flow diagram of a method in accordance with several embodiments;

and

FIG. 8 is a flow diagram of a method in accordance with several embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein for charging and protecting unmanned vehicles. In some embodiments, a system for protecting unmanned aerial vehicle (UAV) navigation system during deliveries of commercial products to customers, the system comprises a flight system configured to provide locomotion to a UAV, a sensor system configured to collect data on the UAV, a communication device configured to communicate with a charger device, a wireless charge receiver configured to receive electrical charge from the charger device to charge a battery on the UAV, and a control circuit coupled to the flight system, the sensor system, the communication device, and the wireless charge receiver. The control circuit being configured to establish wireless communication with the charger device via the communication device, control the flight system to land the UAV on the charger device, cause the UAV to enter a protection mode, wherein the protection mode comprises turning off at least a magnetometer of the sensor system, send a protection mode confirmation signal to the charger device via the communication device to cause the charger device to turn on a wireless charger, and begin to charge the battery with the wireless charger via the wireless charge receiver.

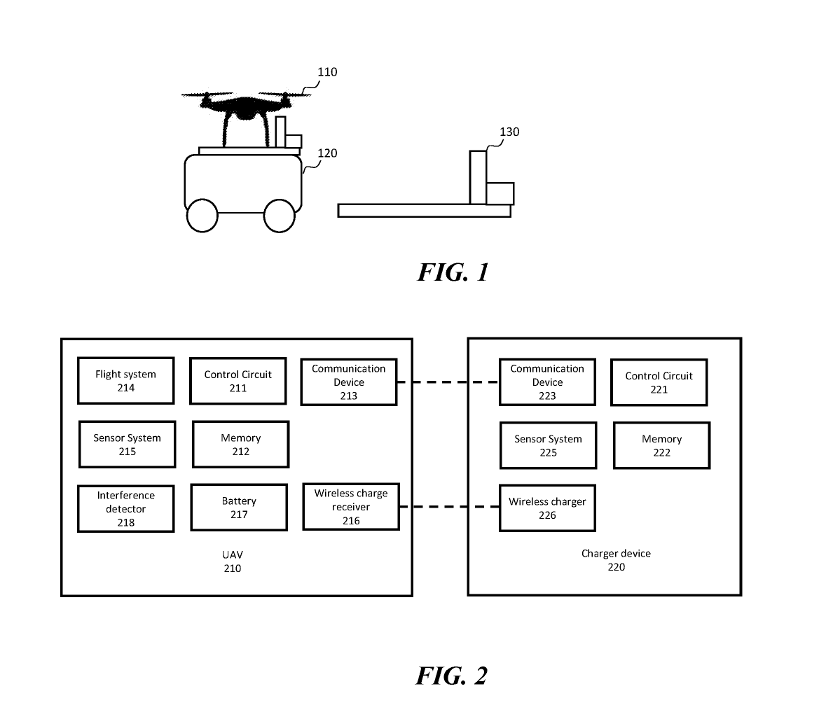

Referring now to FIG. 1, a UAV charging system according to some embodiments is shown. The system includes an unmanned aerial vehicle 110 and one or more of a mobile charger device 120 and a stationary charger device 130. In some embodiments, the system may comprise a plurality of unmanned aerial vehicles 110, mobile charger devices 120, and/or stationary charger devices 130.

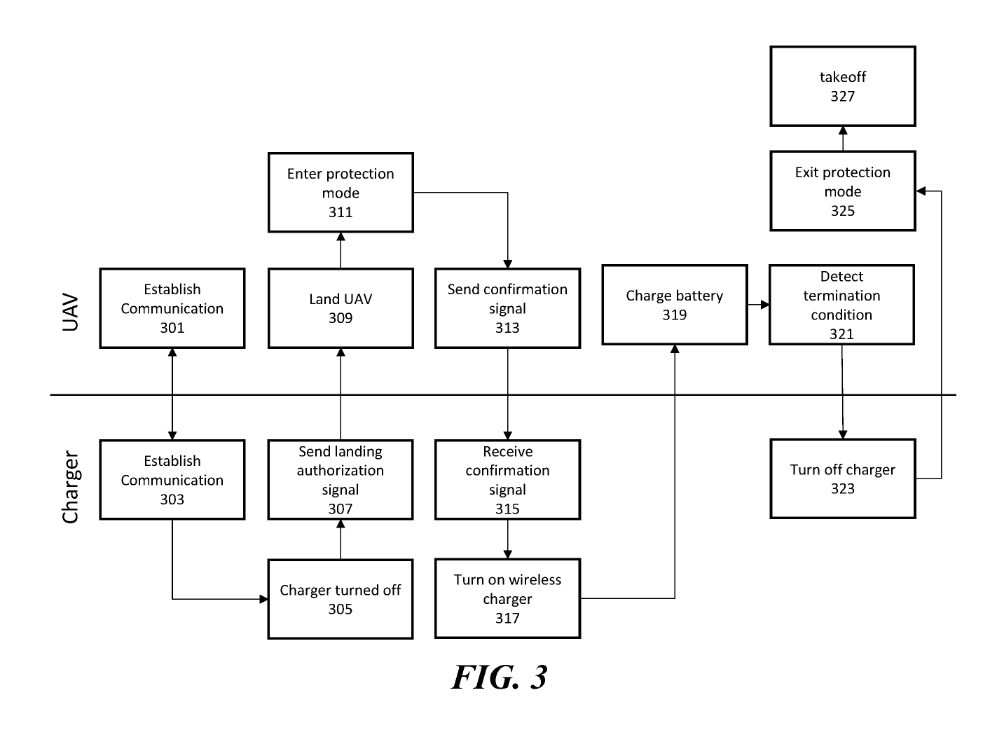

An unmanned aerial vehicle (UAV) 110 may comprise an aerial vehicle configured to travel, perform tasks, and response to travel conditions without a human driver/pilot onboard. While an aerial vehicle is shown in FIG. 1, in some embodiments, the system may be configured to protect one or more of a UAV, an unmanned ground vehicle (UGV), an autonomous vehicle, a self-driving vehicle, a passenger vehicle, a cargo vehicle, etc. during wireless charging. In some embodiments, the vehicle being charged may comprise a vehicle with autonomous, semi-autonomous, remotely piloted, and/or manual modes. In some embodiments, a UAV 110 may be configured to land on the mobile charger device 120 and/or the stationary charger device 130 to recharge its battery. In some embodiments, the UAV 110 may hover near the charger device to be charged. In some embodiments, the UAV 110 may be configured to communicate with the mobile charger device 120 and/or the stationary charger device 130 and enter into a protection mode prior to being charged. In some embodiments, the UAV 110 and the mobile charger device 120 may comprise vehicles traveling in a swarm or a pod. An example of a UAV 110 is described with reference to FIG. 2 herein. In some embodiments, the UAV 110 may be configured to perform one or more steps described with reference to FIGS. 3-8 herein.

In some embodiments, a mobile charger device 120 may comprise a charging station coupled to a vehicle. In some embodiments, the mobile charger device 120 may comprise a UGV configured to travel, perform tasks, and response to travel conditions without a human driver/pilot on board. In some embodiments, the UGV may be a vehicle dedicated to supporting UAVs and may travel to various locations based on the needs of UAVs. While a UGV is shown in FIG. 1, in some embodiments, the mobile charger device 120 may comprise one or more of another UAV, an unmanned watercraft, a self-driving vehicle, a manned vehicle, a conventional ground vehicle, a cargo vehicle, etc. In some embodiments, the mobile charger device 120 may comprise a vehicle with autonomous, semi-autonomous, remotely piloted, and/or manual modes. In some embodiments, a mobile charger device 120 may be configured to provide power to the UAV 110 and/or other types of vehicles. In some embodiments, the mobile charger device 120 may be configured to communicate with the UAV 110 and turn on and off its wireless charger to prevent damages to the instruments/equipment on the UAV 110. In some embodiments, the mobile charger device 120 may further be configured to provide sensor readings to the UAV 110 to assist in the navigation of the UAV 110. An example of a mobile charger device 120 is described with reference to FIG. 2 herein. In some embodiments, the mobile charger device 120 may be configured to perform one or more steps described with reference to FIGS. 3-8 herein.

A stationary charger device 130 may comprise a charging station that generally stays at the same location. In some embodiments, the stationary charger device 130 may be located at a dispatch center and/or at fixed points along the route of the UAV 110. In some embodiments, the system may comprise a network of geographically distributed stationary charger devices 130 in the coverage area of a UAV delivery service. In some embodiments, the stationary charger device 130 may be installed on a building, on the ground, on a tower, on a light post, on a utility pole, etc. In some embodiments, the stationary charger device 130 may be configured to communicate with the UAV 110 and turn on and off its wireless charger to prevent damages to the instruments on the UAV 110. In some embodiments, the stationary charger device 130 may further be configured to provide sensor readings to the UAV 110 to assist in the navigation of the UAV 110. An example of a stationary charger device 130 is described with reference to FIG. 2 herein. In some embodiments, the stationary charger device 130 may be configured to perform one or more steps described with reference to FIGS. 3-8 herein.

Referring now to FIG. 2, a system comprising a UAV 210 and a charger device 220 according to some embodiments is shown. In some embodiments, the UAV 210 may comprise the UAV 110 described with reference to FIG. 1. In some embodiments, the charger device 220 may comprise the mobile charger device 120 and/or the stationary charger device 130 described with reference to FIG. 1.

The UAV 210 may comprise an aerial vehicle configured to travel and perform a variety of tasks. In some embodiments, the UAV 210 may comprise a verticle lift aerial vehicle such as a bicopter, a tricopter, a quadcopter, a hexacopter, an octocopter, etc. In some embodiments, the UAV 210 may be autonomous, semi-autonomous, and/or remotely piloted. In some embodiments, instead of a UAV, the system may be configured to charge a UGV configured to travel on the automobile roadway and/or other types of paths. In some embodiments, the UAV 210 may be configured to carry persons, packages, and/or other types of cargo.

The UAV 210 comprises a control circuit 211, a memory 212, a communication device 213, a flight system 214, a sensor system 215, a wireless charge receiver 216, a battery 217, and an interference detector 218. The control circuit 211 may comprise a processor, a microprocessor, and the like and may be configured to execute computer readable instructions stored on a computer readable storage memory 212. The control circuit 211 may be communicatively coupled to one or more of the memory 212, the communication device 213, the flight system 214, the sensor system 215, the wireless charge receiver 216, the battery 217, and the interference detector 218. The computer readable storage memory 212 may comprise volatile and/or non-volatile memory and have stored upon it a set of computer readable instructions which, when executed by the control circuit 211, causes the control circuit 211 to navigate the UAV 210 and communicate with other devices. Generally, the control circuit 211 may be configured to control the flight system 214 to navigate the UAV 210 based on the sensor system 215 and perform various tasks. The control circuit 211 may be configured to communicate with the charger device 220 to land and charge the battery 217 of the UAV 210 via the wireless charge receiver 216. In some embodiments, the control circuit 211 may further be configured to turn off at least a portion of the sensor system 215 to place the UAV 210 in a protection mode when the UAV 210 is being wirelessly charged by the charger device 220. In some embodiments, the control circuit 211 executing codes stored on the memory 212 may perform one or more steps described with reference to FIGS. 3-8 herein.

The communication device 213 may generally comprise a signal transceiver that allows the control circuit 211 to communicate with another device such as the charger device 220 and/or a central server device. In some embodiments, the communication device 213 may comprise one or more of a WLAN transceiver, a WWAN transceiver, a mobile data network transceiver, a satellite network transceiver, a WiMax transceiver, a Wi-Fi transceiver, a Bluetooth transceiver, a wireless beacon and the like. In some embodiments, the communication device 213 may be configured to form a peer-to-peer network with the charger device 220 and/or other vehicles. In some embodiments, the UAV 210 may receive task assignments, navigation instructions, and/or sensor data through the communication device 213. In some embodiments, the UAV 210 may be configured to autonomously travel and perform tasks for extended periods of time (e.g. hours, days) without communicating with another vehicle, a central server, or the charger device 220.

The flight system 214 may comprise one or more motors that control the speed, direction, and/or orientation of the UAV 210. The flight system 214 may be configured to be controlled by the control circuit 211 to steer and drive the UAV 210 in designated directions. In some embodiments, the flight system 214 may comprise locomotion systems such as rotors and/or propellers of a conventional UAV.

The sensor system 215 may comprise one or more navigation and/or data collection sensors. In some embodiments, the sensor system 215 may comprise one or more location and/or obstacle sensors. In some embodiments, the sensor system 215 may comprise one or more of a magnetometer, an optical sensor, an accelerometer, a gyroscope, a GPS sensor, a virtual mapping processor, a Universal Transverse Mercator (UTM) tracker, and a laser range finder on the UAV, an altitude sensor, and the like. In some embodiments, the sensor system 215 may further comprise one or more environmental sensors such as a wind sensor, a light sensor, an optical sensor, a visibility sensor, a weather sensor, a barometric pressure sensor, a range sensor, a humidity sensor, a sound sensor, a thermal image sensor, a night vision camera, etc.

The wireless charge receiver 216 may generally comprise a device configured to receive electrical charge to charge the battery 217 of the UAV 210 without a wire connection. In some embodiments, the wireless charge receiver 216 may be configured to receive charge via wireless contact charging and/or over-the-air charging. In some embodiments, the wireless charge receiver 216 may comprise an inductive coil, a charging pad, and/or a magnetic resonator. The battery 217 may comprise a power storage device configured to store and supply power to one or more other components of the UAV 210. In some embodiments, the battery 217 may comprise a rechargeable battery such as one or more of, a lithium ion battery, a lithium-ion polymer battery, a lead-acid battery, a nickel-cadmium battery, a nickel-metal hydride battery, a solid state battery, and the like.

The interference detector 218 may comprise a sensor configured to measure the level of electromagnetic interference around the UAV 210. In some embodiments, the interference detector 218 may be configured to measure the strength of electrical and/or magnetic fields around the UAV 210. In some embodiments, the interference detector 218 may comprise one or more sensors described with reference to the sensor system 215 and/or the wireless charge receiver 216. For example, if the wireless charge receiver 216 unexpectedly receives charge while in-flight, the system may determine that there is a high interference. The interference detector 218 may be configured to send a signal to the control circuit 211 when the detected electromagnetic interference exceeds an acceptable threshold level.

FIG. 2 comprises a simplified block diagram of the UAV 210. In some embodiments, the UAV 210 may comprise other known UAV components such as an aerial crane, wings, landing gear, indicator lights, etc. that are omitted for simplicity.

The charger device 220 may comprise a mobile charging station or a stationary charging station configured to provide charge to the UAV 210. In some embodiments, the charger device may comprise one or more of the mobile charger device 120 and the stationary charger device 130 described with reference to FIG. 1 herein. In some embodiments, the charger device 220 may be installed on a ground vehicle, a watercraft, an aerial vehicle, a stationary structure, or the ground. The charger device 220 comprises a control circuit 221, a memory 212, a communication device 223, a sensor system 225, and a wireless charger 226.

The control circuit 221 may comprise a processor, a microprocessor, and the like and may be configured to execute computer readable instructions stored on a computer readable storage memory 222. The control circuit 221 may be communicatively coupled to one or more of the memory 212, the communication device 223, the sensor system 225, and the wireless charger 226. The computer readable storage memory 222 may comprise volatile and/or non-volatile memory and have stored upon it a set of computer readable instructions which, when executed by the control circuit 221, causes the control circuit 221 to communicate with the UAV 210 to provide wireless charging while protecting the instrument/equipment on the UAV 210. In some embodiments, the control circuit 221 executing codes stored on the memory 222 may be configured to perform one or more steps described with reference to FIGS. 3-8 herein.

The communication device 223 may generally comprise a signal transceiver that allows the control circuit 221 to communicate with another device such as the UAV 210 and/or a central server device. In some embodiments, the communication device 223 may comprise one or more of a WLAN transceiver, a WWAN transceiver, a mobile data network transceiver, a satellite network transceiver, a WiMax transceiver, a Wi-Fi transceiver, a Bluetooth transceiver, and the like. In some embodiments, the communication device 223 may be configured to form a peer-to-peer network with the vehicles and/or other charging stations. In some embodiments, the control circuit 221 may use the communication device 223 to authenticate a UAV 210, exchange status information, and/or provide sensor data to the UAV 210.

The wireless charger 226 may generally comprise a device configured to provide charge to another device without a wire connection. In some embodiments, the wireless charger 226 may be configured to provide charge via wireless contact charging and/or over-the-air charging. In some embodiments, the wireless charger 226 may comprise an inductive coil and/or a charging pad. In some embodiments, the wireless charger 226 may further comprise a coupling device configured to secure the UAV 210 while the UAV 210 is being charged. In some embodiments, the coupling device may comprise mechanical and/or magnetic couplers.

The sensor system 225 may comprise one or more navigation and/or data collection sensors. In some embodiments, the sensor system 225 may comprise one or more sensors for capturing data around the charger device 220 and/or locating the charger device 220. In some embodiments, the data collected by the sensor system 225 may be used to assist the UAV 210 during landing and takeoff. In some embodiments, the sensor system 225 may monitor the area around the charger device 220 to determine whether the condition is safe for a UAV 210 to approach and/or land. In some embodiments, data collected by the sensor system 225 may be compared with the data collected by the sensor system 215 of the UAV 210 to determine whether the sensor system 215 of the UAV 210 is functioning properly. In some embodiments, with a charger device 220 implemented on a vehicle (UGV, UAV, etc.), the sensor system 225 may include other navigation sensors of the vehicle such as a magnetometer, an accelerometer, an altitude sensor, a gyroscope, radar, an optical sensor, and the like. In some embodiments, the sensor system 225 may comprise one or more environmental sensors such as a wind sensor, a light sensor, an optical sensor, a visibility sensor, a weather sensor, a barometric pressure sensor, a range sensor, a humidity sensor, a sound sensor, a thermal image sensor, a night vision camera, etc. In some embodiments, the sensor system 225 may be omitted from the charger device 220. For example, a stationary charger device may store the coordinates of its static location and provide that coordinate to the UAV for comparison.

FIG. 2 comprises a simplified block diagram of the charger device 220. The charger device 220 may comprise other components not shown. For example, a charger device 220 implemented on a UGV may comprise other UGV components such as a locomotion system, wheels, a chassis, and the like that are omitted in FIG. 2 for simplicity. In some embodiments, the charger device 220 may share one or more of the control circuit 221, the memory 222, the communication device 223, and the sensor system 225 with the control system of the UGV and/or UAV. In some embodiments, the charger device 220 may be a device installed on a conventional vehicle and comprises a separate control circuit 221 and memory 222.

Referring now to FIG. 3, a method of charging a UAV is shown. In some embodiments, the steps shown in FIG. 3 may be performed by a processor-based device, such as one or more of the UAV 110, the mobile charger device 120, the stationary charger device 130, described with reference to FIG. 1, the UAV 210, the charger device 220 described reference to FIG. 2, and/or other similar devices. In some embodiments, the steps may be performed by one or more of a processor of an autonomous aerial vehicle, an unmanned aerial vehicle, an autonomous ground vehicle, an unmanned ground vehicle, a processor of a charger device, a processor of a charging station, and/or a processor device of a server system.

In steps 301 and 303, a UAV and a charger device establish communication. In some embodiments, the UAV may comprise the UAV 110 described with reference to FIG. 1, the UAV 210 described with reference to FIG. 2, or a similar device. In some embodiments, the charger device may comprise one or more of the mobile charger device 120, the stationary charger device 130 described with reference to FIG. 1, the charger device 220 described reference to FIG. 2, or a similar device. In some embodiments, the communication is established via the communication device 213 of the UAV 210 and the communication device 223 of the charger device 220. In some embodiments, the communication may comprise a private, peer-to-peer, encrypted, secured, and/or broadcasted communication channel. In some embodiments, the communication may be established via an intermediary server or a routing device. In some embodiments, the UAV may send a charge request to the charger device and provide a UAV identifier to obtain landing authorization. In some embodiments, the charger device may be configured to authenticate the UAV and determine whether the UAV is permitted to use the charger device at the requested time. In some embodiments, the charger device may determine whether the wireless charger is available for use based on one or more of the current usage, the predicted usage, and a charging station reservation schedule. In some embodiments, the charger device may monitor its surrounding to determine whether it is safe for the UAV to land. For example, a UGV may deny landing if the UAV is requesting to land near an underpass. In another example, the charger device may deny landing if a bird is currently standing on the charging pad. In some embodiments, the charger device may comprise an interference sensor that monitors the charging area for electromagnetic interference from the charger or other sources. The UAV's landing request may be rejected if the interference exceeds a threshold.

If the charger device determines that the UAV is permitted to land and charge, in step 305, the wireless charger is turned off. In some embodiments, the wireless charger may generally remain off when not in use, and the control circuit of the charger device may verify that the charger is off in step 305. In some embodiments, the wireless charger may be assumed to be off when the not in use, and step 305 may be omitted. In step 307, the charger device sends a landing authorization signal to the UAV to indicate that the charger device is ready for the UAV to approach and/or land.

In step 309, the UAV lands on the charger device using its flight system. In some embodiments, the UAV may use one or more of its sensors to locate the charger device to land and align its wireless charge receiver with the wireless charger of the charger device. In some embodiments, in step 309, the UAV may use an interference detector such as the interference detector 218 to determine whether the wireless charger on the charger device is turned off. The UAV may abort the landing if interference is detected. In some embodiments, the charger device may provide supplemental sensor data to the UAV to assist the landing of the UAV.

In step 311, the UAV enters into a protection mode. In some embodiments, protection mode comprises turning off at least a magnetometer of the sensor system of the UAV. In some embodiments, in protection mode, the UAV further turns off one or more of an optical sensor, an accelerometer, a gyroscope, a GPS sensor, a virtual mapping processor, a Universal Transverse Mercator (UTM) tracker, and a laser range finder on the UAV. In some embodiments, the sensors turned off in protection mode may be dynamically determined based on one or more of detected interference, flight condition, sensors on the charger device, charger device type, and task assignment. For example, a UAV may turn off sensors with matching sensors on the charger device in protection mode and use data collected by the charger device's sensors during landing and/or while charging. In some embodiments, the UAV may further turn off other components of the flight control system in protection mode. In some embodiments, the UAV and/or the charger device may comprise an electromagnetic shielding device. The shielding device may be extended to cover one or more sensors of the UAV in protection mode.

In some embodiments, the UAV may enter into protection mode after it lands on the charger device. In some embodiments, the UAV may enter into protection mode after receiving the landing authorization and prior to landing. In such case, the charger device may send sensor data to the UAV during step 309 to assist in landing the UAV. In some embodiments, the UAV may be configured to land with one or more sensor devices turned off. In some embodiments, the UAV may give at least some of its controls over to the charger device when it is near the charger device and allow the charger station to direct its landing. In some embodiments, the UAV may turn off one set of sensors while landing and turn off a second set of sensor and/or instruments after landing. For example, while landing, the UAV may turn off the magnetometer and rely on other onboard sensors and/or sensors on the charger to land. After landing, the UAV may turn off additional sensors, the flight system, and/or the communication system to charge. In some embodiments, the UAV may comprise a protection mode that is separate from a charge mode.

In steps 313 and 315, the UAV sends a protection mode confirmation signal to the charger device via the communication channel established in steps 301 and 303. In some embodiments, the UAV is configured to send the confirmation signal after the UAV enters into protection mode in step 311 and/or lands in step 309. After receiving the confirmation signal in step 315, the charger device turns on the wireless charger in step 317. In some embodiments, the wireless charger may verify that the UAV has landed using sensors on the charger device. In some embodiments, the wireless charger may be configured to only turn on the wireless charger after receiving a protection mode confirmation signal to prevent damaging the UAV. In some embodiments, the charger device may further engage a docking device to secure the UAV during the charging process in step 315. In some embodiments, electrical power may be transferred from the charger device to the UAV via the wireless charge receiver 216 and wireless charger 226 described with reference to FIG. 2 or similar devices.

In step 319, the UAV begin to charge its battery with the wireless charger of the charger device via a wireless charge receiver. In some embodiments, the UAV may enter into a charge mode and turn off additional devices such as additional sensors, a WWAN transceiver, a WLAN transceiver, a processor, and the like during step 319. In some embodiments, additional devices such as additional sensors, a WWAN transceiver, a WLAN transceiver, a processor may be turned off in protection mode. In some embodiments, the communication device of the UAV is configured to maintain communication with the charger device while the UAV is in protection mode, and the control circuit of the UAV is configured to detect for a charge termination condition based at least in part on data collected by one or more sensors on the charger device.

In step 321, a charge termination condition is detected. A charge termination condition generally refers to one or more conditions that, when satisfied, causes the UAV to stop receiving charge from the charger device and/or takeoff from the charger device. In some embodiments, charge termination condition may be detected by the UAV and/or the charger device. In some embodiments, charge termination condition may comprise the battery being fully charged, the UAV reaching a scheduled departure time and/or location, and/or the UAV reaching the allotted charging time. In some embodiments, when a UAV detects a charge termination condition, the UAV may send a termination signal to the charger device and monitor for a termination confirmation signal from the charger device. In some embodiments, when the charger device detects a termination condition and/or receives a charge terminal signal from the UAV, the charger device turns off the wireless charger in step 323. In some embodiments, the charger device further sends a termination confirmation signal to the UAV in step 323 to notify the UAV that the wireless charger is turned off. In some embodiments, the UAV may determine whether the wireless charger is turned off based on its wireless charge receiver and/or interference detector. In some embodiments, the control circuit of the UAV is configured to keep the UAV in protection mode if electromagnetic interference is detected around the UAV whether a charge termination condition exists.

After the wireless charger is turned off, in step 325, the UAV exits protection mode by turning on one or more sensor devices. In some embodiments, the UAV further exits charge mode in step 325. In some embodiments, the UAV may collect data with the sensor system after exiting the protection mode and prior to takeoff. The UAV may then compare data collected with the sensor system with location data associated with the charger device to determine whether the sensor system is in an error state. In some embodiments, the charger device comprises location sensors configured to determine the location of the charger device. In some embodiments, a stationary charger device may provide its static coordinates to the UAV for comparison. If the sensor system of UAV is not in an error state, the UAV proceeds to step 327 and takes off to continue to perform tasks. In some embodiments, the charger device may further continue to provide sensor data to the UAV to assist with UAV's navigation during takeoff in step 327.

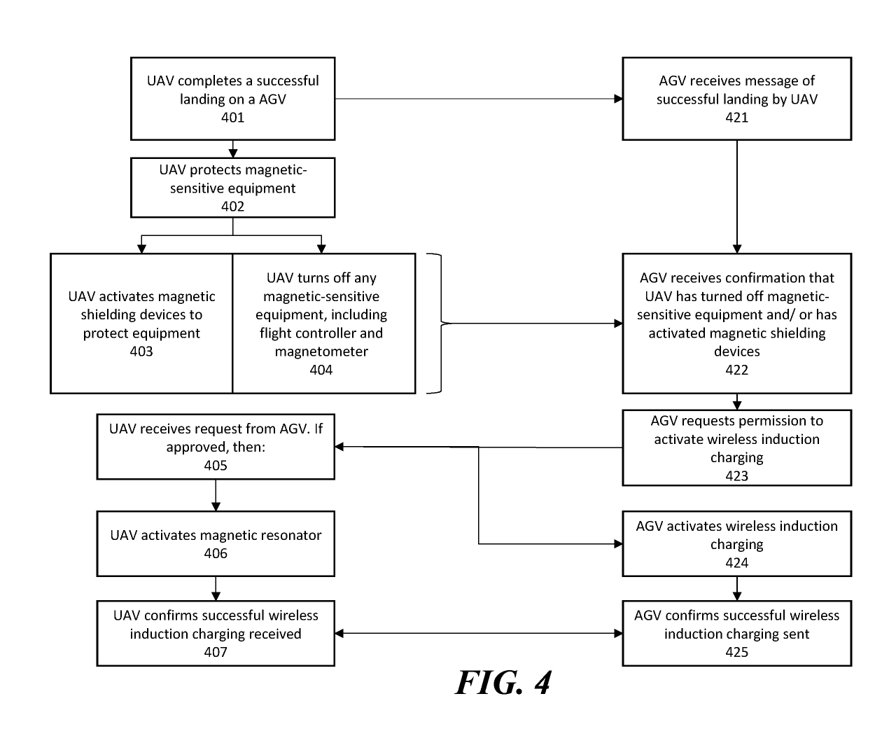

Referring now to FIG. 4, a method of charging a UAV with an autonomous ground vehicle (AGV) is shown. In some embodiments, the steps shown in FIG. 4 may be performed by a processor-based device such as one or more of the UAV 110, the mobile charger device 120, the stationary charger device 130, described with reference to FIG. 1, the UAV 210, the charger device 220 described reference to FIG. 2, and/or other similar devices. In some embodiments, the steps may be performed by one or more of a processor of an autonomous aerial vehicle, an unmanned aerial vehicle, an autonomous ground vehicle, an unmanned ground vehicle, a processor of a charger device, a processor of a charging station, and/or a processor device of a server system.

In step 401, the UAV completes a successful landing on the AGV. In step 402, the UAV protects its magnetic sensitive equipment. In some embodiments, the UAV enters into a protection mode in step 402. The UAV may activate a magnetic shielding device to protect the equipment in step 403 and/or turn off magnetic-sensitive equipment such as the flight controller and the magnetometer in step 404.

In step 421, the AGV receives a message of a successful landing from the UAV and in step 422, the AGV receives confirmation that the UAV has turned off magnetic sensitive equipment and/or has activated magnetic shielding devices. In step 423, the AGV requests permission to activate wireless induction charging. If the UAV receives and approves the request from the AGV, in step 425, the UAV activates a magnetic resonator, a charge capture device and, in step 423, the AGV activates a wireless induction charging device. In step 407, the UAV confirms that wireless induction charging is received and in step 425, the AGV also confirms that wireless induction charging is successfully sent.

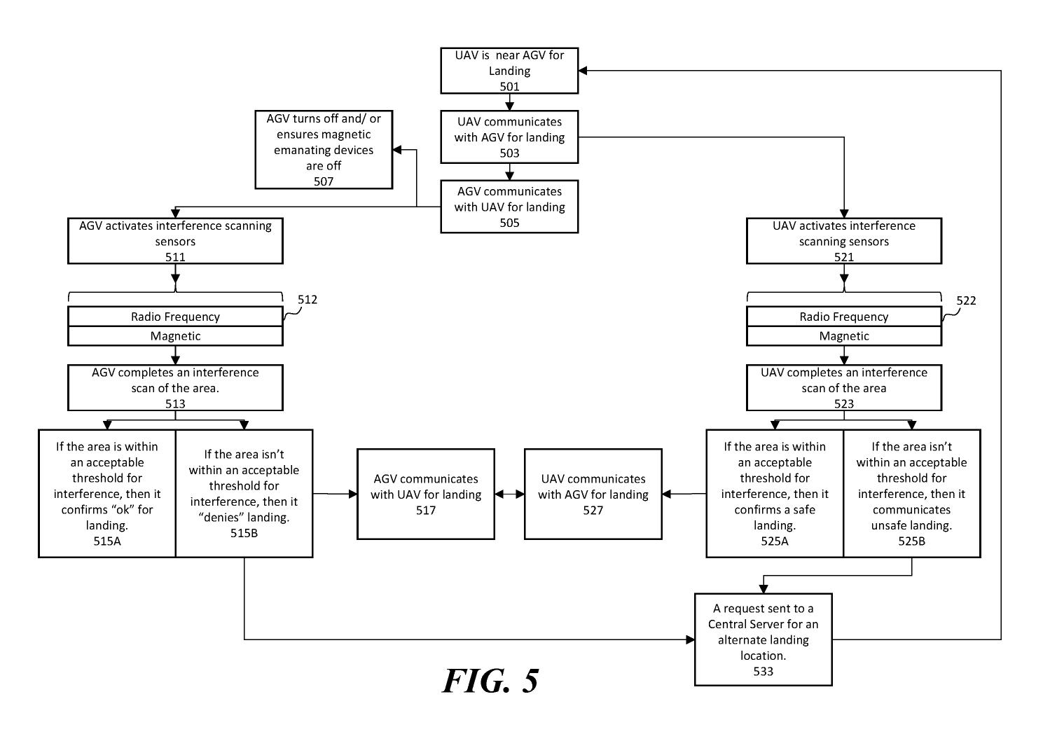

Referring now to FIG. 5, a method of charging a UAV is shown. In some embodiments, the steps shown in FIG. 5 may be performed by a processor-based device such as one or more of the UAV 110, the mobile charger device 120, the stationary charger device 130, described with reference to FIG. 1, the UAV 210, the charger device 220 described reference to FIG. 2, and/or other similar devices. In some embodiments, the steps may be performed by one or more of a processor of an autonomous aerial vehicle, an unmanned aerial vehicle, an autonomous ground vehicle, an unmanned ground vehicle, a processor of a charger device, a processor of a charging station, and/or a processor device of a server system.

In step 501, the UAV is in the vicinity of an AGV. In step 503, the UAV communicates with the AGV for landing. In step 505, the AGV communicates with UAV for landing. In step 507, the AGV turns off and/or ensures that its magnetic emanating devices are off. In step 511, the AGV activates interference scanning sensors, which may include radio frequency and/or magnetic sensors 512. In step 513, the AGV completes an interference scan of the area. If the electromagnetic interference in the area is within an acceptable threshold, then in step 515A, the AGV confirms that it is safe for the UAV to land. If the electromagnetic interference in the area is not within an acceptable threshold, then in step 515B, the AGV denies the landing request from the UAV. In step 517, the AGV communicates with the UAV for landing.

In step 521, the UAV activates interference scanning sensors, which may include radio frequency and/or magnetic sensors 522. In step 523, the UAV completes an interference scan of the area. If the electromagnetic interference in the area is within an acceptable threshold, then in step 525A, the UAV confirms that it is safe to land. If the electromagnetic interference in the area is not within an acceptable threshold, then in step 525B, the UAV aborts landing. In step 527, the UAV communicates with the AGV for landing.

In some embodiments, one or both of the UAV and the AGV may perform interference scans. If one or both of the UAV and the AGV detects high interference in steps 515B and/or 525B, the AGV and/or the UAV may communicate with a central server for an alternate landing location for the UAV in step 533. In some embodiments, the AGV and/or the UAV may be configured to select an alternate landing location. If the request for an alternate landing location is denied and/or no suitable alternate location is found, the process may return to step 501 and landing may be reattempted. If an alternate landing location is found, the UAV and/or AGV may travel to the new location to reattempt landing. In some embodiments, the UAV may reattempt landing with a different AGV or another type of charger device at the alternate location.

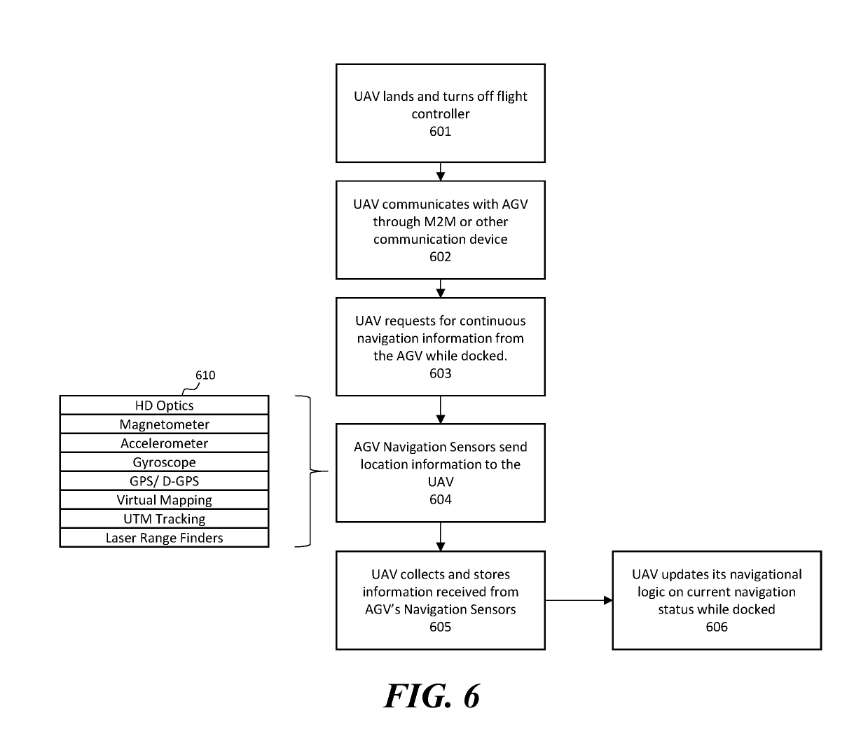

Referring now to FIG. 6, a method of providing sensor information to a UAV while charging is shown. In some embodiments, the steps shown in FIG. 6 may be performed by a processor-based device, such as one or more of the UAV 110, the mobile charger device 120, the stationary charger device 130, described with reference to FIG. 1, the UAV 210, the charger device 220 described reference to FIG. 2, and/or other similar devices. In some embodiments, the steps may be performed by one or more of a processor of an autonomous aerial vehicle, an unmanned aerial vehicle, an autonomous ground vehicle, an unmanned ground vehicle, a processor of a charger device, a processor of a charging station, and/or a processor device of a server system.

In step 601, the UAV lands on an AGV and turns off its flight controller. In some embodiments, step 601 may proceed after steps 515A and/or step 525A described with reference to FIG. 5 herein. In step 602, the UAV communicates with the AGV through M2M or other types of communication devices. In step 603, the UAV requests for continuous navigation information from the AGV while docked on the AGV. In step 604, the navigation sensors of the AGV send location information to the UAV. In some embodiments, the navigation sensors 610 on the AGV may comprise one or more of HD optics, magnetometer, accelerometer, gyroscope, GPS/D-GPS, virtual mapping sensors, UTM tracking sensors, and laser rangefinders. In step 605, the UAV collects and stores information received from the AGV's navigation sensors. In step 606, the UAV updates its navigational logic and status while docked on the AGV. In some embodiments, a UAV may determine when to terminate charging and/or “wake up” to perform tasks based on the sensor information received from the AGV.

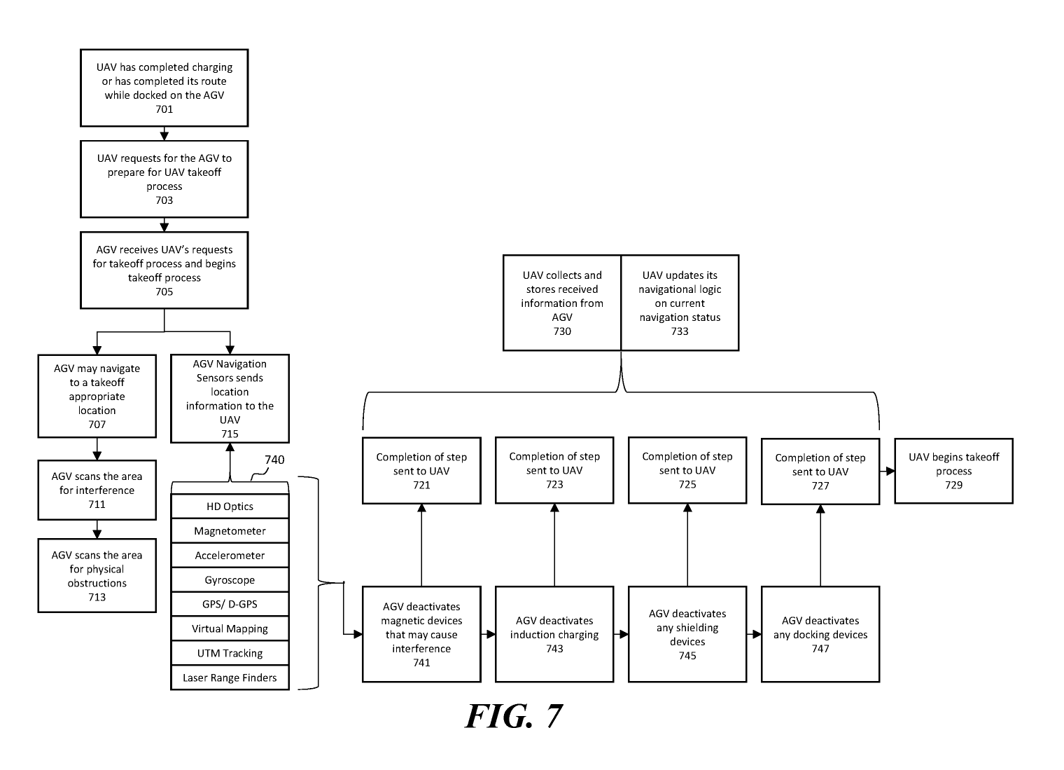

Referring now to FIG. 7, a method of controlling an AGV for UAV takeoff is shown. In some embodiments, the steps shown in FIG. 7 may be performed by a processor-based device, such as one or more of the UAV 110, the mobile charger device 120, the stationary charger device 130, described with reference to FIG. 1, the UAV 210, the charger device 220 described reference to FIG. 2, and/or other similar devices. In some embodiments, the steps may be performed by one or more of a processor of an autonomous aerial vehicle, an unmanned aerial vehicle, an autonomous ground vehicle, an unmanned ground vehicle, a processor of a charger device, a processor of a charging station, and/or a processor device of a server system.

In step 701, the UAV completes charging and reaches a location to undock from the AGV. In step 703, the UAV requests for the UGV to prepare for UAV takeoff. In step 705, the AGV receives the UAV's takeoff request and commence the takeoff process. In step 707, the AGV may travel to a location that is appropriate for UAV takeoff. In some embodiments, the AGV may be configured to slow down or stop briefly to allow for UAV takeoff and/or landing. In step 711, the AGV scans the area for interference. In step 713, the AGV scans the area for physical obstructions. In step 715, the AGV's navigation sensors provide location information to the UAV. In some embodiments, the navigation sensors 740 on the AGV may comprise one or more of HD optics, magnetometer, accelerometer, gyroscope, GPS/D-GPS, virtual mapping sensors, UTM tracking sensors, and laser range finders.

In step 741, the AGV deactivates magnetic devices that may cause interference. In step 743, the AGV deactivates induction charging. In step 745, the AGV deactivates any shielding devices. In step 747, the AGV deactivates any physical docketing devices. With the completion of each of the steps 741, 743, 745, and 747, the AGV may send a confirmation to the UAV in steps 721, 723, 725, and 727 respectively. During this process, the UAV collects and stores information received from the AGV in step 730 and updates its navigation logic on navigation status in step 733. When the confirmation(s) of the completion of the takeoff process on the AGV is received, the UAV begins the takeoff process in step 729.

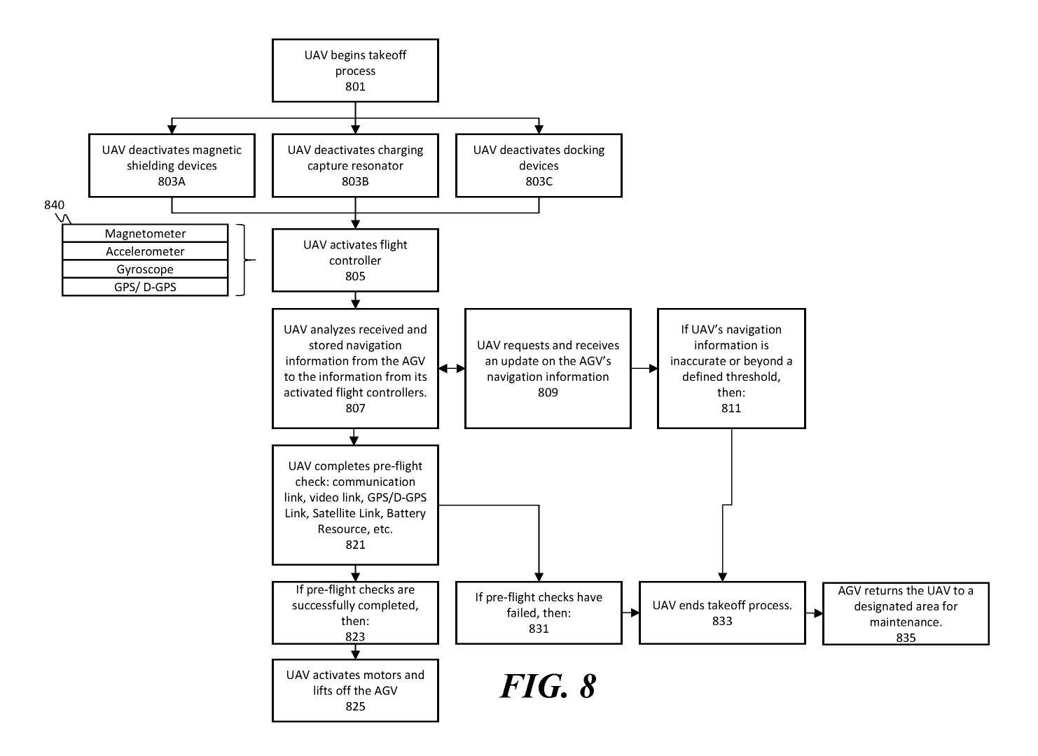

Referring now to FIG. 8, a method of a UAV takeoff from an AGV is shown. In some embodiments, the steps shown in FIG. 8 may be performed by a processor-based device, such as one or more of the UAV 110, the mobile charger device 120, the stationary charger device 130, described with reference to FIG. 1, the UAV 210, the charger device 220 described reference to FIG. 2, and/or other similar devices. In some embodiments, the steps may be performed by one or more of a processor of an autonomous aerial vehicle, an unmanned aerial vehicle, an autonomous ground vehicle, an unmanned ground vehicle, a processor of a charger device, a processor of a charging station, and/or a processor device of a server system.

In step 801, the UAV begins a takeoff process. In some embodiments, step 801 may proceed from step 729 described with reference to FIG. 7 herein. In step 803A, the UAV deactivates magnetic shielding devices. In step 803B, the UAV deactivates a charging capture resonator. In step 803C, the UAV deactivates docking devices. In some embodiments, a docking device may comprise a physical and/or magnetic coupler that secures the UAV on the AGV while the AGV travels. In some embodiments, the docking device may comprise the landing gear of the AGV. In step 805, the UAV activates its flight controller. In some embodiments, the flight controller may comprise sensors 840 comprising one or more of a magnetometer, an accelerometer, a gyroscope, a GPS/D-GPS sensor, etc.

In step 807, the UAV compares the stored navigation information received from the AGV with the information collected by its reactivated flight controller system. In step 809, the UAV requests and receives an update from the AGV's navigation information. In step 811, if the UAV's navigation information is inaccurate or beyond a defined threshold, then in step 833, the UAV ends the takeoff process. In step 821, the UAV performs a pre-flight check of one or more of its systems such as the communication link, the video link, the GPS/D-GPS link, the satellite link, the battery resource, etc. If the pre-flight check fails in step 831, then the UAV also ends take off process in step 833. In step 835, the AVG may return the UAV to a designated area for maintenance. If the pre-flight checks are successfully completed in step 823, then in step 825, the UAV activates motors and lifts off from the AGV.

While FIGS. 4-8 generally describes the charger device as an AGV, in some embodiments, one or more processes may be implemented with a mobile and/or with a stationary charger device described with reference to FIGS. 1-3 herein.

In some embodiments, an AGV with a wireless electromagnetic charging pad for UAV battery refueling is provided. In some embodiments, the system provides a highly efficient, high-powered, resonant magnetic inductive wireless energy transfer for autonomous vehicles to unmanned aerial vehicles. The system integrates an electromagnetic charging pad into the AGV, which provides a resonant magnetic inductive wireless energy transfer to a UAV's battery reservoir. The system streamlines the process for charging of unmanned aerial vehicles by allowing them to be charged by autonomous ground vehicles without a physical connection. AGVs may be strategically placed throughout various locations, so that the unmanned aerial vehicles may be charged on the way to their destinations.

Unmanned Aerial Vehicles have a limited capacity for battery life. Thus, finding relevant solutions to recharge UAVs is a concern for the retailer using UAVs for deliveries. In some embodiments, the system's main components may include the base charging unit and the vehicle's charging unit. In some embodiments, the system includes one or more of a power supply, a base pad, a wireless power and data transfer device, a vehicle pad, an onboard controller, a battery, and a beacon system for communication of location and availability of AGV's charging station with the UAV.

In some embodiments, coils within the power source resonator generate magnetic fields. And when a UAV passes over an AGV's field, an electric current is induced in its secondary coil. Electric power connection on the AGV provides power to the primary induction coils. In some embodiments, the coils on the AGV generate magnetic fields only when an autonomous vehicles power capture resonator is above the charging system. In some embodiments, the secondary induction coil is affixed to the autonomous vehicle system, which provides charging for the battery pack.

In some embodiments, the charger devices comprise on/off functionality. In some embodiments, AGV communicates, in advance, its location, destination, and availability before the UAV docks on the AGV which allows for a more a dynamic approach to the allocation of ground vehicles to aerial vehicles. In some embodiments, the UAV may shut down many of its sensors when docked onto an AGV. In some embodiments, the sensor may be selectively turned on and off based on the interference found in the area. In some embodiments, the UAV may comprise interference sensors for verifying the availability of a safe spot.

In some embodiments, to charge a UAV with an AGV, the UAV first approaches and communicates with AGV and lands on AGV. The UAV then communicates that it has landed on the AGV and that its flight controller is turned off to avoid magnetic interference and damage to the flight controller and magnetometer. The AGV then turns on its magnetic induction wireless charging. In some embodiments, the UAV and the AGV may communicate their current positions through M2M. When the UAV and AGV arrive at the location of a disconnection, determined through a signal communicated from the UAV to the AGV or from a previously scheduled break off point, the AGV communicates that it has turned off its induction. The UAV will then turn on its flight controller and fly away.

In some embodiments, the AGV may use sensors to detect for other interference in the area. With a mobile charger device, interference levels may vary with the environment. In some embodiments, the UAV may detect interference before it lands to ensure a safe landing without magnetic interference.

In some embodiments, a system for protecting unmanned aerial vehicle (UAV) navigation system during deliveries of commercial products to customers, the system comprises a flight system configured to provide locomotion to a UAV, a sensor system configured to collect data on the UAV, a communication device configured to communicate with a charger device, a wireless charge receiver configured to receive electrical charge from the charger device to charge a battery on the UAV, and a control circuit coupled to the flight system, the sensor system, the communication device, and the wireless charge receiver. The control circuit being configured to establish wireless communication with the charger device via the communication device, control the flight system to land the UAV on the charger device, cause the UAV to enter a protection mode, wherein the protection mode comprises turning off at least a magnetometer of the sensor system, send a protection mode confirmation signal to the charger device via the communication device to cause the charger device to turn on a wireless charger, and begin to charge the battery with the wireless charger via the wireless charge receiver.

In some embodiments, a method for protecting unmanned aerial vehicle (UAV) navigation system during deliveries of commercial products to customers comprises establishing, with a communication device on a UAV, wireless communication with a charger device, controlling a flight system for providing locomotion to the UAV to land the UAV on the charger device, causing, with a control circuit of the UAV, the UAV to enter a protection mode, wherein the protection mode comprises turning off at least a magnetometer of a sensor system configured to collect data on the UAV, sending a protection mode confirmation signal to the charger device via the communication device to cause the charger device to turn on a wireless charger, and beginning to charge a battery of the UAV with electrical charge received from the wireless charger via a wireless charge receiver.

In some embodiments, a method for protecting unmanned aerial vehicle (UAV) navigation system during deliveries of commercial products to customers comprises establishing wireless communication between a UAV and a charger device, sending a landing authorization signal from the charger device to the UAV while a wireless charger on the charger device is turned off, receiving a protection mode confirmation signal from the UAV at the charger device, turning on the wireless charger on the charger device to charge a battery of the UAV, providing sensor data to the UAV while the UAV is being charged, and turning off the wireless charger in response to detecting a charge terminal condition associated with the UAV.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for protecting unmanned aerial vehicle (UAV) navigation system during deliveries of commercial products to customers, the system comprising:
a flight system configured to provide locomotion to a UAV;
a sensor system configured to collect data on the UAV;
a communication device configured to communicate with a charger device;
a wireless charge receiver configured to receive electrical charge from the charger device to charge a battery on the UAV; and
a control circuit coupled to the flight system, the sensor system, the communication device, and the wireless charge receiver, the control circuit being configured to:
establish wireless communication with the charger device via the communication device;
control the flight system to land the UAV on the charger device;
cause the UAV to enter a protection mode, wherein the protection mode comprises turning off at least a magnetometer of the sensor system;
send a protection mode confirmation signal to the charger device via the communication device to cause the charger device to turn on a wireless charger; and
begin to charge the battery with the wireless charger via the wireless charge receiver.

2. The system of claim 1, wherein the wireless charge receiver and the wireless charger each comprises an inductive coil.

3. The system of claim 1, wherein the charger device comprises one or more of a ground vehicle, an unmanned ground vehicle (UGV), a stationary charging station, and a mobile charging station.

4. The system of claim 1, wherein the protection mode further comprises turning off one or more of an optical sensor, an accelerometer, a gyroscope, a GPS sensor, a virtual mapping processor, a Universal Transverse Mercator (UTM) tracker, and a laser range finder on the UAV.

5. The system of claim 1, wherein the control circuit is further configured to:
detect a charge termination condition;
send a termination signal to the charger device;
monitor for a termination confirmation signal from the charger device; and
exit the protection mode in response to receiving the termination confirmation signal.

6. The system of claim 1, wherein the control circuit is further configured to:
collect data with the sensor system after exiting the protection mode; and
compare data collected with the sensor system with location data associated with the charger device to determine whether the sensor system is in an error state.

7. The system of claim 1, wherein the communication device is configured to maintain communication with the charger device while the UAV is the protection mode, and the control circuit is further configured to detect for a charge termination condition based at least in part on data collected by one or more sensors on the charger device.

8. The system of claim 1, further comprising an interference detector, wherein the control circuit is configured to detect for electromagnetic interference around the UAV before causing the UAV to land on the charger device.

9. The system of claim 1, further comprising an interference detector, wherein the control circuit is configured to keep the UAV in the protection mode if electromagnetic interference is detected around the UAV whether a charge termination condition exists.

10. The system of claim 1, wherein the control circuit is configured to use data collected by one or more sensors of the charger device to land the UAV on the charger device.

11. A method for protecting unmanned aerial vehicle (UAV) navigation system during deliveries of commercial products to customers, the method comprising:
establishing, with a communication device on a UAV, wireless communication with a charger device;
controlling a flight system for providing locomotion to the UAV to land the UAV on the charger device;
causing, with a control circuit of the UAV, the UAV to enter a protection mode, wherein the protection mode comprises turning off at least a magnetometer of a sensor system configured to collect data on the UAV;
sending a protection mode confirmation signal to the charger device via the communication device to cause the charger device to turn on a wireless charger; and
beginning to charge a battery of the UAV with electrical charge received from the wireless charger via a wireless charge receiver.

12. The method of claim 11, wherein the wireless charge receiver and the wireless charger each comprises an inductive coil.

13. The method of claim 11, wherein the charger device comprises one or more of a ground vehicle, an unmanned ground vehicle (UGV), a stationary charging station, and a mobile charging station.

14. The method of claim 11, wherein the protection mode further comprises turning off one or more of an optical sensor, an accelerometer, a gyroscope, a GPS sensor, a virtual mapping processor, a Universal Transverse Mercator (UTM) tracker, and a laser range finder on the UAV.

15. The method of claim 11, further comprising:
detecting a charge termination condition;
sending a termination signal to the charger device;
monitoring for a termination confirmation signal from the charger device; and
exiting the protection mode in response to receiving the termination confirmation signal.

16. The method of claim 11, further comprising:
collecting data with the sensor system after exiting the protection mode; and
comparing data collected with the sensor system with location data associated with the charger device to determine whether the sensor system is in an error state.

17. The method of claim 11, wherein the communication device is configured to maintain communication with the charger device while the UAV is in the protection mode, and a charge termination condition is determined based at least in part on data collected by one or more sensors on the charger device.

18. The method of claim 11, further comprising:
detecting for electromagnetic interference around the UAV before causing the UAV to land on the charger device.

19. The method of claim 11, further comprising:
keeping the UAV in the protection mode if electromagnetic interference is detected around the UAV whether a charge termination condition exists.

20. The method of claim 11, further comprising
receiving data collected by one or more sensors of the charger device to land the UAV on the charger device.

21. A method for protecting unmanned aerial vehicle (UAV) navigation system during deliveries of commercial products to customers, comprising:
establishing wireless communication between a UAV and a charger device;
sending a landing authorization signal from the charger device to the UAV while a wireless charger on the charger device is turned off;
receiving a protection mode confirmation signal from the UAV at the charger device;
turning on the wireless charger on the charger device to charge a battery of the UAV;
providing sensor data to the UAV while the UAV is being charged; and
turning off the wireless charger in response to detecting a charge terminal condition associated with the UAV.
